(19) United States
(12) Patent Application Publication
(10) Pub. No.: US 2007/0197114 A1
(43) Pub. Date: Aug. 23, 2007

(54) Wear resistant coating composition for a veil product

(76) Inventor: Dale A. Grove, Pataskala, OH (US)

Correspondence Address: OWENS CORNING, 2790 COLUMBUS ROAD, GRANVILLE, OH, 43023, US

(21) Appl. No.: 11/360,728

(22) Filed: Feb. 23, 2006

(51) Int. Cl. B32B 5/02; B32B 17/02; B32B 27/30; B32B 11/00; B32B 13/02

(52) U.S. Cl. 442/180; 442/59; 442/172; 442/173; 442/174; 442/178; 442/179; 428/294.7

(57) ABSTRACT

A coating composition that contains hard particles, a binder, and at least one thickening agent is provided. Pigment materials, a dispersant, a biocide, and a defoaming agent may also be included. The particles may have a size of about 1.0 to about 20.0 microns and a hardness of at least 5 on the Mohs Hardness Scale. The hard particles may be present in the composition in an amount from about 2.0 to about 15.0% by weight of the composition. The coating composition may be applied to a veil to form a wear resistant coating. The coated veil may then be used to form a coated gypsum product. The coating composition improves wear resistance and reduces damaging effects that may be caused by winding, workers handling the coated gypsum product during installation, and/or adverse conditions after installation. Methods of forming a coated veil and coated gypsum products are also provided.

### TECHNICAL FIELD AND INDUSTRIAL APPLICABILITY OF THE INVENTION

The present invention relates generally to coating compositions for veils, and more particularly, to a coating composition for a veil that provides improved wear resistance to the coating layer. Methods of forming coated veils that apply the wear resistant coating in-line or off-line during the manufacturing process are also provided.

### BACKGROUND OF THE INVENTION

Wall boards formed of a gypsum core sandwiched between facing layers are commonly used in the construction industry as internal walls and ceilings for both residential and commercial buildings. Facing materials advantageously contribute flexibility, nail pull resistance, and impact strength to the materials forming the gypsum core. In addition, the facing material can provide a fairly durable surface and/or other desirable properties (e.g., a decorative surface) to the gypsum board. The gypsum core typically contains gypsum, optionally some wet chopped glass fibers, water resistant chemicals, binders, accelerants, and low-density fillers. It is known in the art to form gypsum boards by providing a continuous layer of a facing material, such as a fibrous veil, and depositing a gypsum slurry onto the bottom surface of the facing material. A second continuous layer of facing material is then applied to the top surface of the gypsum slurry. The sandwiched gypsum slurry is then sized for thickness and dried to harden the gypsum core and form a gypsum board. Next, the gypsum board may be cut to a predetermined length for end-use.

Glass fibers are commonly used in the production of gypsum wall boards to improve the tensile and tear strength of the products. The fibers may be employed in many forms, including individual fibers, strands containing plural fibers, and rovings. These fiber products, in turn, may be used in discrete form or they may be assembled into woven or non-woven fabrics or mats and incorporated into a gypsum matrix. Alternatively, the fibrous mats may be used as the facing material. For example, glass fibers may be formed by drawing molten glass into filaments through a bushing or orifice plate and applying an aqueous sizing composition containing lubricants, coupling agents, and film-forming binder resins to the filaments. The sizing composition provides protection to the fibers from interfilament abrasion and promotes compatibility between the glass fibers and the matrix in which the glass fibers are to be used. After the sizing composition is applied, the wet fibers may be gathered into one or more strands, chopped, and collected as wet chopped fiber strands.

The wet chopped fibers may then be used in wet-laid processes in which the wet chopped fibers are dispersed in a water slurry that contains surfactants, viscosity modifiers, defoaming agents, and/or other chemical agents. The slurry containing the chopped fibers is then agitated so that the fibers become dispersed throughout the slurry. Next, the slurry containing the fibers is deposited onto a moving screen where a substantial portion of the water is removed to form a web. A binder is then applied, and the resulting mat is dried to remove any remaining water and to cure the binder. The formed non-woven veil is an assembly of dispersed, randomly-oriented individual glass filaments.

It has become commonplace in the industry to utilize such fibrous, wet-laid, non-woven veils as facing materials for gypsum wall boards. Glass fiber facings provide increased dimensional stability in the presence of moisture, biological resistance, and greater physical and mechanical properties than conventional gypsum boards faced with paper or other cellulosic facing materials. It has also become known in the industry to coat the fibrous glass mats with a composition to deliver a specific desired additive or to obtain specific desired properties such as better touch. Some examples of coatings for glass veils known in the art are set forth below.

U.S. Pat. No. 4,645,709 to Klare teaches a coating for a woven glass fabric that contains a silicone oil, a particulate solid, and a high molecular weight polytetrafluoroethylene or elastomeric fluoropolymer. The fluoropolymer coating is used to increase strength, weatherability, flexibility, and resistance to the flex wear of the fabric to which it is applied. The particulate solid materials preferably have a diameter of less than 0.3 microns.

U.S. Patent Publication No. 2003/0175478 to Leclercq discloses a plasterboard that has on one of its sides a coated glass fiber mat facing. The glass fiber mat facing is coated with a coating composition that includes a mineral filler (excluding hydratable calcium sulfates), an organic or mineral binder, and optionally a water-repelling agent. It is asserted that the coating reduces the occurrence of free fibers and improves the surface appearance of the boards. The mineral filler includes mineral fillers that release water, such as hydrated alumina, calcium carbonate, white kaolin, clays, and combinations thereof. The binder may be an organic or mineral binder and includes binders such as ethylene/vinyl acetate copolymers, ethylene/vinyl versatate and vinyl acetate/vinyl versatate copolymers, polyacrylics, vinyl acetate/acrylic copolymers, styrene/acrylic copolymers, vinyl acetate/vinyl versatate/acrylic terpolymers, and blends thereof. The water-repelling agent is either a fluorocarbon or a silicone oil.

U.S. Patent Publication Nos. 2004/0121075 to Grove III, et al. and 2004/0121075 to Geel et al. disclose methods for forming decorative wall or acoustic veils that include adding decorative particles to a formulation that includes a high loading of flame retardant fillers (e.g., calcium carbonate, aluminum trihydrate, magnesium hydroxide, and the like). The coating formulation may also include thickeners, whiteners, anti-static agents, antimicrobial agents, fungicides, optical whiteners, pigments, and/or pH adjusters. The particle size of the decorative particles preferably ranges from about 100 to about 500 microns and is preferably added to the mat in an amount from about 0.5 to about 10%. Examples of suitable decorative particles include mica, thermoplastic or thermosetting polyester glitter, expandable graphite, alumina, glass beads, clay, and calcium carbonate.

High toughness, abrasion resistance, and abuse resistance are desirable properties in gypsum-based boards used in buildings. Although the glass fiber veil facings provide strength, dimensional stability, mold resistance, and better touch to the gypsum boards, there is a need to improve upon the wear-resistance of gypsum boards. In this regard, new testing standards for improving the wear-resistance of gypsum boards for interior use has been established. As discussed above, coatings have been applied to glass veils for a variety of reasons. However, none of the prior art coatings are sufficient to meet the stringent requirements set forth in ASTM C-1629. It is therefore desirable to provide a formulation and methods for forming a coated veil and gypsum board that improves wear resistance of the gypsum boards and meets and/or exceeds the new wear resistant standards according to ASTM C-1629.

### SUMMARY OF THE INVENTION

It is an object of the present invention to provide a wear resistant coating composition for a non-woven fibrous veil. The coating composition includes hard particles that increase or improve the hardness of the coating on the veil. The coating composition provides sufficient wear resistance to meet and/or exceed the stringent testing requirements of ASTM C-1629 for gypsum boards. In preferred embodiments, the particles are about 1.0 to about 20.0 microns in size and have a hardness of at least 5 on the Mohs Hardness Scale. The hard particles may be present in the composition in an amount of from about 2.0 to about 15.0% by weight of the total composition. Hard particles for use in the present composition include particles such as alumina, pumice, feldspar, barite minerals, quartz, diamond, boron carbide, cuttlebone, gamet, silicone carbide, tungsten carbide, zirconium, amalgan, topaz, aptite, and combinations thereof. In addition, the coating composition includes at least one fairly low glass transition (T_{g}) organic binder optionally combined with at least one primary filler/pigment material. The organic binder may be present in the composition in an amount from about 7.0 to about 15.0% by weight and the filler/pigment material may be present in the composition in an amount from about 1.0 to about 15% by weight. Examples of suitable low glass transition organic binders include, but are not limited to, styrene-butadiene-rubber (SBR) based resins, styrene-acrylate resins, acrylic resins, polyvinylacetate, polyvinyl alcohol, polyethylene, vinyl versatate, and/or a vinyl-acrylic binder, whether in direct contact or in copolymer form with one or more binders in this list optionally combined with small levels of crosslinkable resins such as melamine, thermoset acrylics, phenolics, urea-formaldehyde, epoxies, and/or polyurethanes. Suitable primary fillers/pigment materials include calcium carbonate, talc, aluminum hydroxide, magnesium hydroxide, mica, phyllosilicates, zinc oxide, mixed oxides, iron oxides, chromates, silicates, bauxite, and sand. The coating composition preferably includes about 0.2 to about 0.7% by weight of a thickening agent. Additionally, the coating composition may include about 0.05 to about 0.15% by weight of at least one defoaming agent, about 0.3 to about 1.0% by weight of at least one dispersant, and about 0.01 to about 0.5% by weight of at least one biocide. Water is typically present in the composition in an amount from about 20 to about 24% by weight. The viscosity of the coating composition is preferably a thickness that allows partial penetration of the coating composition into the veil. In exemplary embodiments, the viscosity of the coating composition falls in the range of about 700 to about 1500 cps as measured by a Brookfield viscometer with a #2 spindle at 100 rpm.

It is another object of the present invention to provide a wear resistant coated facing material that includes a non-woven fibrous veil coated on one side with the coating composition described above. It is desirable to coat one major side of the fibrous veil so that the second major side of the fibrous veil is available to mechanically bond with gypsum to form a gypsum board. The fibrous veil may be formed of randomly oriented glass fibers, natural fibers, mineral fibers, carbon fibers, ceramic fibers, and/or synthetic fibers. Such a random dispersion of fibers in the veil is preferred since the resulting product that employs the coated fibrous veil (e.g. a coated gypsum board) should be capable of installation in any direction without showing preferential markings. It is preferred that the fibrous veil is formed entirely of glass fibers due to their low cost, mold resistance, dimensional stability, and high tensile strength and modulus. In preferred embodiments, the thickness of the coating composition on the fibrous veil is a thickness that is sufficient to retard or prevent the flow of gypsum entirely through the fibrous veil. Additionally, the coated facing material may be reinforced with a fibrous mat or veil product such as a continuous filament mat, woven fabrics, meltbond materials, spunbond non-wovens, or long fiber dry-laid non-woven mats to improve the impact strength of the coated facing material. The reinforcing mat or veil may be mechanically or chemically bonded to a second major surface of the non-woven fibrous veil.

It is also an object of the present invention to provide a wear resistant gypsum board that includes an inner core of gypsum, a base veil mechanically bonded to and surrounding the gypsum core, and a wear resistant coating layer coating the external surface of the base veil. The coating layer is formed of the coating composition described in detail above and provides sufficient wear resistance to meet and/or exceed the stringent testing requirements of ASTM C-1629 for gypsum boards. The base veil is formed of a plurality of randomly oriented reinforcement fibers bonded with a conventional binder resin such as urea-formaldehyde. The reinforcement fibers forming the base veil may be glass fibers, mineral fibers, carbon fibers, ceramic fibers, and/or synthetic fibers. Glass fibers are preferred due to their low cost and high strength.

It is an advantage of the present invention that the presence of the hard particles in the inventive coating composition form a coating layer that is less likely to abrade or wear off the product to which it is applied. Thus, for example, a gypsum board coated with the inventive coating composition is more wear resistant than conventional gypsum boards and reduces damaging effects that may be caused by items such as mother nature, shipping, workers handling the veil prior to and during installation, and/or adverse conditions after installation.

It is another advantage of the present invention that a coating layer formed of the inventive wear resistant coating composition is less susceptible to being removed by the removal of wall paper or other decorative appliques from the coated gypsum board.

It is a further advantage of the present invention that the coating composition helps to reduce the occurrence of loose glass fibers, thereby reducing any potential irritation to workers handling the coated veils and installing the coated gypsum boards that may be caused by loose glass fibers.

It is yet another advantage of the present invention that the coating composition provides sufficient wear resistance to the coated gypsum boards to meet and/or pass the stringent requirements of ASTM C-1629.

It is another advantage of the present invention that gypsum boards coated with the inventive coating composition are more dimensionally stable than standard paper faced gypsum boards.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of a processing line for forming a base veil according to at least one aspect of the present invention;

FIG. 2 is a schematic illustration of a meniscus dip/floating knife processing line for forming a coated veil according to at least one embodiment of the present invention;

FIG. 3 is a schematic illustration of a coated veil formed of a veil and a coating layer according to at least one exemplary embodiment of the present invention;

FIG. 4 is a schematic illustration of a fountain flow/knife processing line for forming a coated veil according to at least one exemplary embodiment of the present invention;

FIG. 5 is a schematic illustration of a reinforced coated veil formed according to at least one exemplary embodiment of the present invention;

FIG. 6 is a schematic illustration of a processing line for forming a wear resistant coated gypsum board according to an exemplary embodiment of the present invention; and

FIG. 7 is a schematic illustration of a wear resistant coated gypsum board according to at least one embodiment of the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, “upper”, “lower” and the like are used herein for the purpose of explanation only. It will be understood that when an element is referred to as being “on,” another element, it can be directly on or against the other element or intervening element(s) may be present. The terms “veil”, “mat”, and “facer” may be used interchangeably herein. Additionally, the term “formulation” may be interchangeably used with “composition”. It is to be noted that the phrases “size composition”, “sizing composition”, and “size” may be used interchangeably herein.

The present invention relates to (1) a coating composition that may be used to form a coating layer on a fibrous, non-woven veil that improves the wear resistance of the coating layer and reduces damaging effects that may be caused by winding, by mother nature, workers handling the veil prior to and during installation, and/or adverse conditions after installation, and (2) methods of forming veils that have the wear resistant coating composition applied thereto. The coated veils may be used as facing materials in forming a coated gypsum board. The coating composition provides sufficient wear resistance to meet and/or exceed the stringent testing requirements of ASTM C-1629 for gypsum boards. The wear resistant, coated veil may be used as surface coverings such as for ceilings and floors and for dry wall applications.

The coating composition includes hard particles that increase or improve the hardness of the coating layer on the veil. In general, the particles may be of any suitable size, shape, and density. The size of the particles preferably range from about 1.0 to about 20.0 microns. Particles ground or precipitated to be smaller than about 1.0 micron tend to be expensive and are thus undesirable. Particles in excess of 20.0 microns are subject to settling effects, which may result in application problems due to the inability of the particles to stay in suspension in the composition. Large particles may also create problems in the winding process since they may protrude through one mat layer and into the next layer.

Suitable examples of particles for use in the coating composition include, but are not limited to, particles such as alumina, pumice, feldspar, barite minerals, quartz, diamond, boron carbide, cuttlebone, garnet, silicone carbide, tungsten carbide, zirconium, amalgan, topaz, aptite, and combinations thereof. It is preferred that the particles are hard mineral particles having a hardness of at least 5 on the Mohs Hardness Scale. The hard particles may be present in the composition in an amount of about 2.0 to about 15.0% by weight, preferably in an amount of about 2.0 to 7.0% by weight. As used herein, the term “% by weight” is meant to indicate a percent by weight of the total composition. It is believed that at a concentration below approximately 2.0% by weight, the coating layer on the veil wears quickly against the hard metallic brushes used in abrasion wear tests, and thus may not provide sufficient hardness to pass the standards of ASTM C-1629. Further, a concentration above approximately 15.0% by weight may wear the coating on the veil more quickly due to the larger amount of particles in the composition, which tend to accumulate within the metal brush during abrasion testing and wear the coating more rapidly.

In some exemplary embodiments, the coating composition may include some “plate-like” shaped particles to assist in closing the coating layer and to achieve lower coating weights. Lower coating weights are advantageous because a lower coating weight enables a greater amount of reinforcement fibers (e.g., glass fibers) that are not coated with the coating composition to strongly bind to gypsum, such as the gypsum slurry described below. This strong bond between the reinforcement fibers and the gypsum reduces blistering and other defects commonly associated with the formation of gypsum boards. In addition, the coating composition may optionally contain acicular particles to reinforce the coating layer.

In some applications outside the realm of ASTM C-1629, it is desirable to have a softer, more flexible coating. To improve the flexibility of the veil, plastic additives such as molybdenite minerals (e.g., molybdenum) and/or a low coefficient of friction material such as polyethyleneterephalate, silicones, or waxes may be included in the composition instead of the hard particles. These additives may be present in the composition in an amount of about 0.1-10.0% by weight, preferably in an amount of about 0.1-2.0% by weight.

Additionally, the coating composition includes a binder to hold the hard particles together in the coating layer of the veil. The binder may include at least one fairly low glass transition (T_{g}) organic binder. Examples of suitable low glass transition organic binders include, but are not limited to, styrene-butadiene-rubber (SBR) based resins, styrene-acrylate resins, acrylic resins, polyvinylacetate, polyvinyl alcohol, polyethylene, vinyl versatate, and/or a vinyl-acrylic binder, whether in direct contact or in copolymer form with another binder in this list of organic binders, optionally combined with small levels of crosslinkable resins such as melamine, thermoset acrylics, phenolics, urea-formaldehyde, epoxies, and/or polyurethanes. For the purposes of this invention, a fairly low glass transition temperature is meant to be defined as a glass transition temperature with a range of about +25° C. to about −30° C. The binder may be present in the coating composition in an amount of about 7.0 to about 15.0% by weight, preferably in an amount of about 9.0 to about 14.0% by weight. Insufficient binder levels may decrease the wear resistance of the coating because poorly adhered particles are more susceptible to being worn or torn off.

In addition, the coating composition preferably includes about 0.2 to about 0.7% by weight of at least one thickening agent. The presence of thickeners in the formulation can provide added desirable attributes. For example, the thickening agent helps to prevent particle settling and provides resistance to shear or elongation rate striation markings that may arise under processing conditions. Examples of thickeners that may be used in the coating composition include polyurethane thickeners, alkali thickeners, polyacrylamides, and hydrophobically modified alkali swellable emulsions (HASE). Organic thickeners are not preferred and are typically avoided because organic compounds are a food source for both mold and bacterial growth.

The coating composition may also include at least one primary filler/pigment material. Preferably, at least one of the primary fillers/pigment materials includes plate like particles to help the coating layer achieve a lower porosity and/or high Gurley values, which indicates a more closed or more breathable coating layer. Examples of suitable primary fillers/pigment materials include calcium carbonate, talc, aluminum hydroxide, magnesium hydroxide, mica, polyphillates, zinc oxide, mixed oxides, iron oxides, chromates, silicates, bauxite, and sand. The primary filler materials/pigments preferably have a hardness of less than 5 on the Mohs Hardness Scale. In addition, the primary fillers desirably possess flame retardant properties and/or actively fight the advancement of a flame. For example, fillers/pigments such as aluminum trihydrate, magnesium hydroxide, and bauxite release water and nitrogen-phosphorous additives such as ammonium polyphosphate or diammonium phosphate act to form chars. The primary filler/pigment materials may be present in the composition in an amount from about 5.0 to about 50.0% by weight and have particle sizes up to about 10 microns. In preferred embodiments, the primary fillers include ground calcium carbonate, which may be present in the composition in an amount from about 5.5 to about 50% percent by weight with a particle size of about 10 microns or less, and/or talc, which may be present in the composition in an amount from about 5.0 to about 20.0% by weight with a particle size of about 10 microns or less.

Additionally, the coating composition may include up to about 0.15% by weight, preferably about 0.05 to about 0.15% by weight of at least one defoaming agent and up to about 0.1% by weight, preferably about 0.3 to about 1.0% by weight of a dispersant such as polyacrylate dispersants. Water is typically present in the composition in an amount from about 20 to about 24% by weight. Further, the formulation may include antimicrobial agents, fungicides, and/or biocides. The fouling of veils primarily occurs through accumulated charged particles, biological growth, and fungal growth. Biological or fungal attacks are more typically a problem in pools, showers, and other hot, humid environments, but can also occur in any surface covering or dry wall application. Examples of suitable biocides for use in the inventive composition include diiodomethyl-p-tolylsulfone, glutarealdehyde, thionazin, zinc oxide, zinc omadine, and silver. To prevent discoloration or unwanted microbiological or fungal attack, the biocides, antimicrobial, and/or antifungal agents may be present in the composition in an amount up to about 0.5% by weight, preferably about 0.01 to about 0.5% by weight, and more preferably from about 0.05 to about 0.15% by weight.

The coating composition of the present invention may also optionally contain conventional additives such as dyes, coupling agents, fillers, thermal stabilizers, anti-oxidants, wetting agents, colorants, and UV stabilizers. The amount of additives present in the coating composition is preferably not in excess of approximately 3.0% by weight.

The viscosity of the coating composition is preferably a thickness that allows only partial penetration of the coating composition into the veil. In exemplary embodiments, the viscosity of the coating composition may fall in the range of about 700 to about 1500 cps as measured by a Brookfield viscosity at 100 rpm with a #2 spindle. It is to be noted that the coating layer may display some pseudoplasticity. Ideally, the coating composition is positioned on only one side of the veil so that the reinforcement fibers forming the veil are exposed to gypsum penetration and mechanical bonding. The amount of the defoamer present in the composition should be sufficient to combat the foam during both the coating and application manufacturing steps, while, at the same time, not ruining the hydrophobicity of the coating as measured by a Cobb test. Cobb number pick-ups may be from about 0.05 to about 0.7 gram pick-up per T-441 test procedure. In preferred embodiments, the dispersant is added in a quantity that is sufficient to fully disperse the fillers/pigments such that the viscosity returns or nearly returns to the viscosity of water prior to the addition of the thickening agent. Concentrations higher than that needed to fully disperse the pigments in the coating composition are not desirable due to the possible deterioration of hydrophobicity performance of the coating layer.

In forming the coating composition, the components of the composition may be added to a high speed disperser like a Cowles blade or high shear mixer and agitated for a period of time to grind the hard particles and fillers/pigments to their primary size. To adequately grind the particles, a high rpm (>1000 rpm) Cowles blade may be used in combination with a baffling system to reduce or eliminate the presence of foam in the coating composition. Typically, the coating composition is agitated for a period of about 15 to about 45 minutes. Particle sizes may be determined through standard grind tests known to those in the industry or by coating a glossy piece of paper and looking for particles that are visible to the naked eye. Preferably, the order of the addition of the components of the coating composition is as follows: water, a defoaming agent, a binder, a dispersing agent, a biocide, primary fillers (e.g., calcium carbonate and talc), hard particles, and a thickening agent. It is desirable that the defoaming agent is added prior to the addition of the dispersant or latex binder because these components typically produce foam. It is also feasible to add the binder after the addition of the primary fillers and the hard particles, but prior to the addition of the thickening agent, as a further means of reducing foam generation. In addition, baffles may be used to help reduce the level of foam that is produced during the formation of the coating composition and that may enter into the coating layer on the coated veil discussed in detail below.

A preferred coating composition according to the present invention is set forth in Table 1.

TABLE 1

| Component | % by weight |
|---|---|
| Water | 20.0-24.0 |
| Defoaming agent | 0.05-0.15 |
| Binder | 7.0-15.0 |
| Dispersant | 0.3-1.0 |
| Biocide | 0.05-0.15 |
| Talc | 5.0-20.0 |
| CaCO₃ | 5.0-50.0 |
| Hard Particles | 2.5-15.0 |
| Thickening agent | 0.2-0.7 |

In operation, the wear resistant coating composition may be applied to a pre-cursor glass fiber veil that is formed by a wet laid process. The glass fibers used to form the coated veil may be any type of glass fiber, such as A-type glass fibers, C-type glass fibers, E-type glass fibers, S-type glass fibers, ECR-type glass fibers (e.g., Advantex® glass fibers commercially available from Owens Corning), wool glass fibers, or combinations thereof. In at least one preferred embodiment, the glass fibers are wet use chopped strand glass fibers (WUCS). Wet use chopped strand glass fibers may be formed by conventional processes known in the art. It is desirable that the wet use chopped strand glass fibers have a moisture content of from about 5.0 to about 20.0% by weight and even more desirably a moisture content of from about 10.0 to about 15.0% by weight.

The use of other reinforcing fibers such as natural fibers, mineral fibers, carbon fibers, ceramic fibers, and/or synthetic fibers such as polyester, polyethylene, polyethylene terephthalate, and/or polypropylene in the coated veil is considered to be within the purview of the invention. However, it is preferred that all of the fibers forming the veil are glass fibers due to their low cost and high tensile strength and modulus. The presence of synthetic fibers may be advantageous when higher impact resistance is sought. In general, the inclusion of organic fibers is not desirable because these fibers detract from mold resistance, which is a desirable feature in gypsum board applications.

Glass fibers may be formed by attenuating streams of a molten glass material from a bushing or orifice. The attenuated glass fibers may have diameters from about 8 to about 23 microns, preferably from about 10 to about 16 microns. After the glass fibers are drawn from the bushing, an aqueous sizing composition is applied to the fibers. The sizing may be applied by conventional methods such as by an application roller or by spraying the size directly onto the fibers. The size composition typically includes one or more film forming agents (such as a polyurethane film former, a polyvinyl alcohol film former, a polyester film former, and/or an epoxy resin film former), at least one lubricant, and at least one silane coupling agent (such as an aminosilane or methacryloxy silane coupling agent). The size protects the glass fibers from breakage during subsequent processing, helps to retard interfilament abrasion, provides better hot wet strength retention, and ensures the integrity of the strands of glass fibers, especially during the chopping process. The fibers may be chopped to a length of about 0.125 to about 1.5 inches, and preferably to a length of 0.25 to about 1.0 inches.

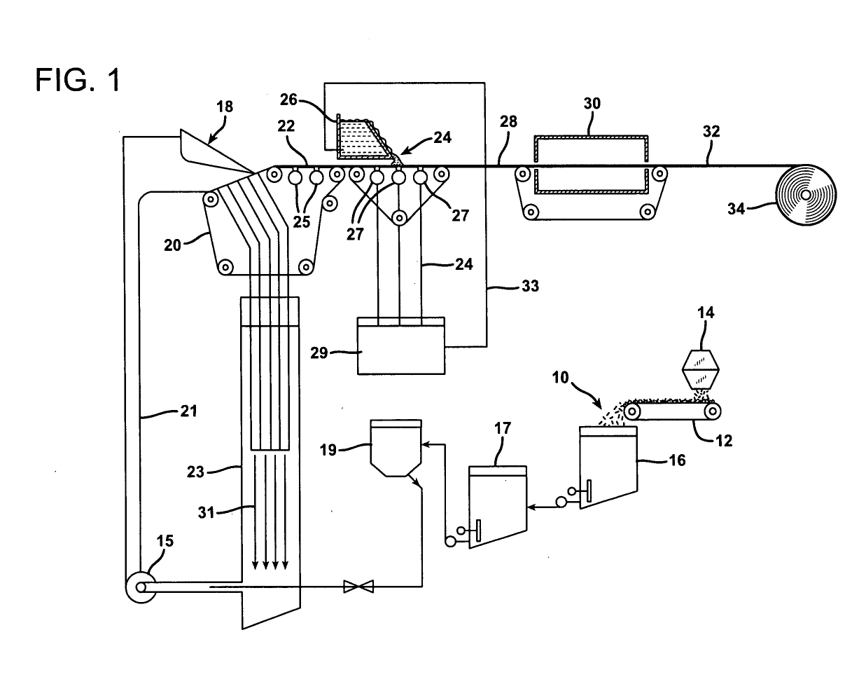

The veil or mat may be formed by a wet-laid process such as is illustrated in FIG. 1. For example, in forming the mat or veil, wet chopped glass fibers 10 may be deposited onto a conveyor 12 from a fiber feed system 14. The chopped glass fibers 10 may be placed into a pulper or mixing tank 16 that contains various surfactants, viscosity modifiers, defoaming agents, and/or other chemical agents with agitation to form a chopped glass fiber slurry (not shown). The conglomeration of chemicals in the mixing tank is commonly termed “white water”. The glass fiber slurry may be passed through a machine chest 17 and a constant level chest 19 to further disperse the fibers 10 in the whitewater. The chopped glass slurry may then be transferred from the constant level chest 19, diluted in a thin-stock stream from a silo 23 and pumped via a fan pump 15 to a head box 18 by line 21. The glass fiber slurry is then deposited onto a moving screen or wire 20 where a substantial portion of the water from the slurry is removed via gravity through head pressure within the headbox 18 to form a web 22. Excess whitewater 31 is removed and deposited into silo 23. Whitewater may be further removed from the web 22 by a conventional vacuum or air suction system such as vacuums 25. A diluted binder 24 is then applied to the web 22 by a binder applicator such as a curtain coater 26. It is to be appreciated that any suitable binder applicator may be used, and a curtain coater 26 is only one illustrative example of a suitable binder applicator. The diluted binder 24 may be supplied via line 33 from a binder supply tank 29. Fresh binder (e.g. concentrated binder) may be supplied to the binder supply tank 29 from a binder supply (not illustrated) to maintain a constant level of binder 24 in the binder supply tank 29 to supply to the curtain coater 26. Excess binder may be vacuumed from the web 22 by vacuum or air suction apparatuses 27 and deposited into a binder supply tank 29. The binder 24 may be any suitable conventional binder such as an acrylic binder, a styrene acrylonitrile binder, a styrene butadiene rubber binder, vinyl-acrylic, polyvinyl acetate, polyvinyl alcohol, a urea formaldehyde binder, a thermoset acrylic, a melamine binder, or mixtures thereof. However, urea-formaldehyde binders are generally the most preferred binder due to its low cost. In addition, the binder 24 preferably includes some crosslinking to preserve the hot tensile strength of the binder-coated web 28 through the subsequent coating of the coating composition onto the base veil 32. A standard thermosetting acrylic binder formed of polyacrylic acid and at least one polyol (e.g., glycerin) combined with a thermoplastic acrylic is a preferred method when low free formaldehyde is required. In addition, the binder 24 may optionally contain conventional additives for the improvement of process and product performance, such as dyes, coupling agents, fillers, thermal stabilizers, anti-oxidants, wetting agents, colorants, and/or UV stabilizers.

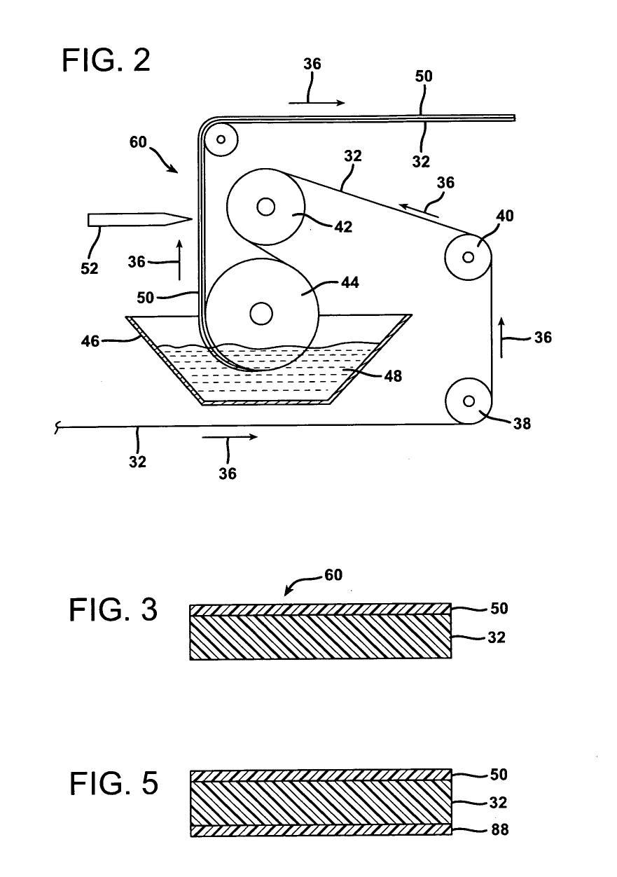

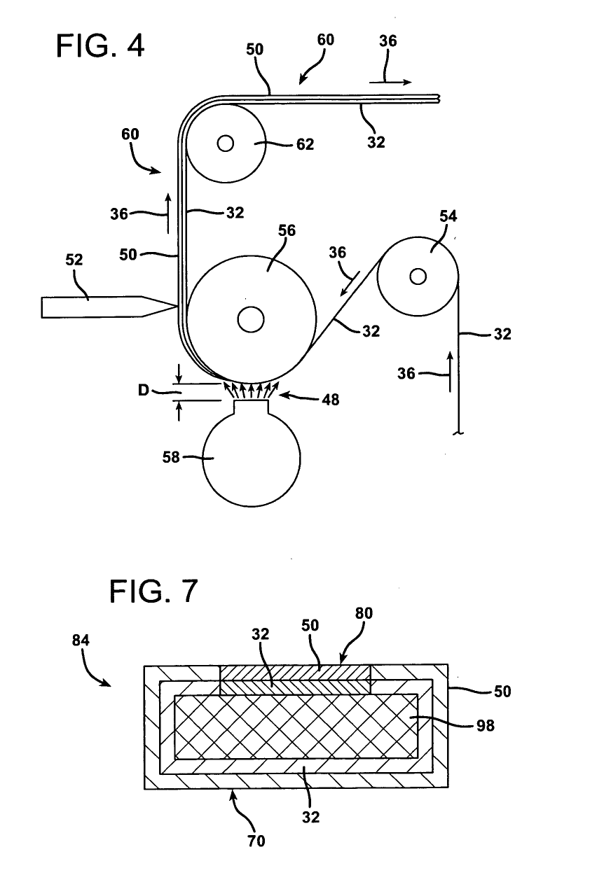

The binder-coated web 28 is then passed through a drying oven 30 to remove any remaining water and to cure the binder 24. The formed non-woven chopped strand base mat or base veil 32 that emerges from the oven 30 includes randomly dispersed glass fibers. Randomly dispersed fiber orientation is preferred since the resulting product (e.g., a coated gypsum board) which employs a base veil 32 should be capable of installation in any direction without showing preferential markings. The base veil 32 may be subsequently treated with binder impregnation steps, painting steps, and/or particle application steps (not shown). As depicted in FIG. 1, the base veil 32 may be rolled onto a take-up roll 34 for storage for later use. The basis weight of the base veil 32 is dependent upon the desired porosity and desired tensile strength. The base veil 32 has two major surfaces (e.g., a smooth side, which faces the wire 20, and a rough side) and two minor surfaces. It is to be appreciated that the method depicted in FIG. 1 may be joined with the coating application methods depicted in FIGS. 2 and 4 to produce a wear-resistant coated veil in-line, such as when a large volume of coated veils is desired. Alternatively, a coated veil may be produced in off-line coating processes, preferably through methods like a meniscus dip followed by a floating knife (FIG. 2), a fountain flow applicator followed by a floating knife (FIG. 4), a slot die with sufficient filtering (not shown), and possibly a curtain coater (not shown).

In one exemplary embodiment illustrated in FIG. 2, the coated veil 60 is formed on a meniscus dip/floating knife processing line. The base veil 32 is moved in the direction of arrows 36 past a series of rollers 38, 40, 42 which direct the base veil 32 into a bath container 46 containing the wear resistant coating composition 48 described in detail above. As the base veil 32 passes application roller 44, it is dipped into the upper portion of the coating composition 48 (e.g., a nearly “meniscus dip”). As a result, a coating layer 50 formed of the coating composition 48 is applied to one major surface of the base veil 32. A floating knife 52 is positioned a short distance from the application roller 44 to remove any excess coating composition 48 and smooth out the coating layer 50 to form a substantially even coating of the coating composition 48 on the base veil 32. As used herein, the phrase “substantially even coating” is meant to indicate an even coating or a substantially even coating of the coating composition. In a preferred embodiment, the floating knife 52 is positioned a distance within about ¼ diameter of the application roller 44. The wear-resistant coated veil 60 thus formed and generally depicted in FIG. 3 contains a base veil 32 and a coating layer 50.

It is to be appreciated that the presence of nip or pressure points (such as flood and extract methods, kiss coating, secondary formers, and dry application methods) or nip rolls in the processes is avoided in preferred methods of applying the coating composition 48 to the base veil 32 because the application pressure supplied by the nip points or nip rolls may force the coating composition 48 entirely through the base veil 32. As discussed above, it is desirable to coat one major side of the base veil 32 so that the base veil 32 is present on the other major side of the coated veil 60 to mechanically bond with gypsum in later processing steps. It is also desirable for the coating layer 50 to be as thin as possible on the base veil 32 but not too thin such that gypsum can pass through the coating layer 50 and into the base veil 32 in subsequent processing steps. In addition, the thickness of the coating layer 50 should be a thickness that is sufficient to retard or prevent the flow of gypsum entirely through the coated veil 60. An example of a suitable range for the thickness of the coating layer 50 may be about 0.05 to about 0.20 mm. Further, the coating composition 48 may penetrate a distance that is a small portion of the base veil 32.

The amount of coating composition 48 that is applied to the base veil 32 and the amount of coating composition 48 that impregnates the base veil 32 is at least partially dependent upon the line speed and the amount of time the base veil 32 is located in the coating composition 48. For example, a larger application roller 44 would permit the base veil 32 to be submersed in the coating composition 48 for a longer period of time than a smaller application roller 44. Similarly, a slower line speed would keep the base veil 32 in the coating composition 48 for a longer period of time compared to a fast line speed. The impregnation of the coating composition 48 into the base veil 32 is also affected by the geometry of the knife 52 and the pressure generated by the knife 52 on the coating layer 50. The thickness of the coating layer 50 can be roughly estimated by taking the basis weight of the coating layer 50 and dividing it by the density (which should include air entrainment if it exists).

In one exemplary embodiment illustrated in FIG. 4, the coated veil 60 is formed on a fountain flow/knife processing line. As shown in FIG. 4, the base veil 32 is moved in the direction of arrows 36 past roller 54 to application roller 56. The application roller 56 is positioned a distance D above a fountain flow apparatus 58 that contains a quantity of the coating composition 48. The fountain flow apparatus 58 sprays the coating composition 48 in an upwardly direction in a fountain-like manner to apply a coating layer 50 of the coating composition 48 to the base veil 32. The distance D is preferably a distance that allows for a broad and substantially even coating of the coating composition 48 onto one major surface of the base veil 32 without a substantial loss of coating composition 48 into the air. The amount of coating composition 48 applied to the base veil 32 is dependent upon the line speed and the amount of coating composition 48 that is projected from the fountain flow apparatus 58. The amount of impregnation of the coating composition 48 into the base veil 32 from the fountain flow apparatus 58 is dependent upon the velocity of the coating composition 48 that is projected towards the base veil 32, the openness of the veil 32 (e.g., permeability and hole size distribution), the viscosity of the coating composition 48, the surface tension of the coating composition 48, the contact angle of the surface of the base veil 32 with the coating composition 48, and the time period that the base veil 32 is subject to the stream of coating composition 48 from the fountain flow apparatus 58. The flow out of the fountain flow apparatus 58 is dependent upon the pump setting. A knife 52 is preferably positioned adjacent to or substantially adjacent to the application roller 56 to remove any excess coating composition 48, to force additional wet-out as desired, and to smooth out the coating layer 50. However, the knife 52 may be positioned a short distance from the application roller 56. The coated veil 60 may then be passed over roller 62 and conveyed to a drying apparatus (not shown).

In an alternate embodiment, the wear resistant coating composition is applied to a base veil that has been treated with a pre-binder added to the white water in the mixing tank in the wet-laid process described above and depicted in FIG. 1. Examples of suitable pre-binders for use in the white water include polyvinyl alcohol, polyvinyl pyrolidone, and urea-formaldehyde based binders. Polyvinyl alcohol is the most preferred pre-binder. Initial binder concentrations may range from about 15.0 to about 30.0% by weight in the impregnated mat. If polyvinyl alcohol is the binder of choice, it may be pre-treated with hot water, dissolved, cooled, and then added to the white water along with the chopped fibers and other white water components such as an anionic polyacrylamide, dispersants, defoamers, and biocides.

In some applications, higher impact strength may be desired for the coated veil 60. In such an application, a fibrous mat or veil product 88 such as a continuous filament mat, woven fabrics, meltbond materials, spunbond non-wovens, or long fiber dry-laid non-woven mats may be mechanically or chemically attached to the base veil of the coated veil product described above. If the coated veil is combined with a fabric, it may be done in-line with a coating process to reduce the economical impact of a separate, off-line process. An example of a increased impact coated veil is illustrated in FIG. 5.

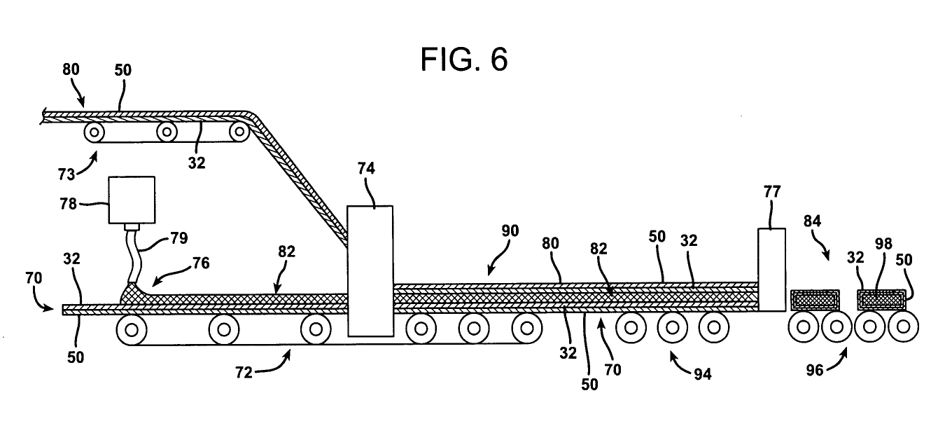

In at least one exemplary embodiment of the present invention, the coated veil 60 may be subsequently processed in a gypsum or foam facer process. In the embodiment illustrated in FIG. 6, the coated veil 60 is used to form a coated gypsum board 84. A first coated veil 70 is conveyed by a first conveying apparatus 72 (e.g., a conveyor), to a forming area 74. In preferred embodiments, the first conveying apparatus 72 is a conveyor belt. The first coated veil 70 is positioned such that the base veil 32 is facing upwardly (e.g., away from the first conveying apparatus 72) and the coating layer 50 is positioned adjacent to the first conveying apparatus 72. A gypsum slurry 76 is deposited from a gypsum supply 78 via a depositing apparatus such as a hose 79 or a series of hoses (not shown) to the base veil 32 of the first coated veil 70. The gypsum slurry 76 may be a conventional gypsum slurry composed of water, gypsum (CaSO₄.2H₂O), various accelerants, binders, and water repellency chemicals.

A second coated veil 80 is simultaneously conveyed to the forming area 74 by a second conveying apparatus 73. The second coated veil 80 may be a coated veil that is the same as, or different from, the first coated veil 70. It is preferred, however, that the first and second coated veils 70, 80 are the same as or similar to each other to avoid warpage. At the forming area 74, the second coated veil 80 is applied to the gypsum slurry layer 82 in a manner such that the base veil 32 of the second coated veil 80 is placed in contact with the gypsum layer 82. In addition, in the forming area 74, the first coated veil 70 is folded around the gypsum layer 82. It is to be appreciated that the first coated veil 70 is larger than the second coated veil 80, which permits the first coated veil 70 to be “wrapped” around the sides of the gypsum layer 82. The forming area 74 and the amount of gypsum slurry 76 that is deposited onto the first coated veil 70 are sized such that the gypsum slurry 72 gets compressed into both first and second coated veils 70, 80. The base veils 32 of the first and second coated veils 70, 80 mechanically interlock with the gypsum layer 82. As a result, no chemical additives or adhesives are needed to bond the base veils 32 and the gypsum layer 82. The resulting product is an intermediate sandwiched gypsum composite 90 formed of a gypsum layer 82 sandwiched between two coated veils 70, 80 with a wear-resistant coating on the external major and minor surfaces. It is to be noted that in FIG. 6, the intermediate sandwiched gypsum composite 90 is depicted without a wear resistant coating on a minor side so that the layering of the first and second veils 70, 80 and the gypsum layer 82 can be seen.

The intermediate sandwiched gypsum composite product 90 is preferably initially supported by a conveyor 72 or other similar conveying apparatus. After sufficient green strength is obtained, which arises from the natural reactions of gypsum over time, the conveyor belt 72 ends and a series of rollers 94 conveys the intermediate sandwiched gypsum product 90 to a cutting apparatus 77 (e.g., a knife) where the intermediate gypsum product 90 is cut into individual coated gypsum boards 84. The coated gypsum board 84 is formed of an inner gypsum core 98 mechanically bonded to the base veils 32 of the first and second coated veils 70, 80 with a surrounding wear resistant coating layer 50. A coated gypsum board 84 formed according to the present invention is depicted in FIG. 7. Although a conveyer 72 and a series of rollers 94 are depicted as carrying devices for the intermediate sandwiched gypsum composite 90, it is to be appreciated that a series of conveyors or other similar conveying apparatuses known to those of skill in the art could be used to carry the intermediate sandwiched gypsum composite product 90 from the forming area 74 to the cutting apparatus 77.

After the intermediate sandwiched gypsum composite 90 has been cut into discrete coated gypsum boards 84, the coated gypsum boards 84 may be subsequently conveyed by a second series of rollers 96 to a drying apparatus (not shown) such as a multi-zone dryer to further dry the gypsum. The distance from the forming area 74 to the cutting apparatus 77 is a distance sufficient to provide a green strength that is strong enough to cut the intermediate sandwiched gypsum product 90 into the coated gypsum boards 84 without any breakage or warpage of the coated gypsum boards 84. In practice, the distance may be a distance of 200 or more feet, depending on the line speed.

There are numerous advantages provided by the wear resistant coating composition of the present invention. For instance, the presence of the hard particles in the composition make the coating layer less likely to abrade or wear off the product to which it is applied. Thus, for example, a gypsum board coated with the coating composition as described above is more wear resistant than conventional gypsum boards and reduces damaging effects that may be caused by winding, by mother nature, by shipping, by workers handling the veil prior to and during installation, and/or adverse conditions after installation. In addition, the wear resistant coating is less susceptible to being removed by the removal of wall paper or other decorative sticky appliques from the coated gypsum board. Additionally, the coating composition helps to reduce the occurrence of loose or “fly-away” glass fibers, thereby reducing any potential irritation to workers handling the coated veils and installing the coated gypsum boards that may be caused by the glass fibers.

A further advantage of the coating composition is that it provides sufficient wear resistance to the coated gypsum boards to pass the stringent requirements of ASTM C-1629. Yet another advantage of the present invention is that the coated gypsum boards are more dimensionally stable than standard paper faced gypsum boards.

Having generally described this invention, a further understanding can be obtained by reference to certain specific examples illustrated below which are provided for purposes of illustration only and are not intended to be all inclusive or limiting unless otherwise specified.

### EXAMPLE

Coating Composition

A coating composition was formed by adding 24% water, 0.1% of a defoaming agent (Foamkill CPD, a defoamer commercially available from Crucible Chemicals), 15% of a styrene-acrylate binder (NW1845K, a styrene-acrylate binder commercially available from Rohm and Haas), 0.6% of a dispersant (Darvan 811, a dispersant commercially available from RT Vanderbilt, 0.1% of a flowable amical biocide from Dow Biocides, 39.7% of a 3 micron, ground calcium carbonate (e.g., Hubercarb 3, a ground calcium carbonate commercially available from J M Huber), 15% of talc at 3-7 microns (Nytal 200 talc, available commercially from R T Vanderbilt), 5% pumice (NCS-10 pummice commercially available from Hess, and 0.5% of a thickening agent (Acrysol RM-5 thickener available commercially from Rohm and Haas) in a container. The mixture was combined in the order given above and mixed with a high degree of agitation with a Cowles blade agitator for a period of time sufficient to grind the particles to nearly their primary size. Typically, the time period for mixing the coating composition is approximately 15-45 minutes. Baffles were used to reduce the level of foam that may enter the coating, which would provide a negative impact on the closeness of the coating. After the mixture has been agitated to grind the particles to nearly their primary size, the mixture was ready for application to a precursor veil.

Having generally described this invention, a further understanding can be obtained by reference to certain specific examples illustrated below which are provided for purposes of illustration only and are not intended to be all inclusive or limiting unless otherwise specified.

Having thus described the invention, what is claimed is:

1. A wear resistant coating composition for a non-woven fibrous veil comprising:
a fairly low glass transition organic binder;
at least one thickening agent; and
particles having a hardness of at least 5 on the Mohs Hardness Scale and a particle size from about 1.0 micron to about 20.0 microns.

2. The wear resistant coating composition of claim 1, further comprising at least one pigment material.

3. The wear resistant coating composition of claim 2, wherein said at least one pigment material has a particle size less than about 10 microns.

4. The wear resistant coating composition of claim 2, wherein said at least one pigment material is at least one member selected from the group consisting of calcium carbonate, talc, aluminum hydroxide, magnesium hydroxide, mica, phyllosilicates, zinc oxide, iron oxides, chromates, silicates, bauxite and sand.

5. The wear resistant coating composition of claim 2, further comprising at least one member selected from the group consisting of at least one defoaming agent, at least one dispersing agent and at least one biocide.

6. The wear resistant coating composition of claim 1, wherein said particles are selected from the group consisting of alumina, pumice, feldspar, barite minerals, quartz, diamond, boron carbide, cuttlebone, garnet, silicone carbide, tungsten carbide, zirconium, amalgan, topaz, aptite and combinations thereof.

7. The wear resistant coating composition of claim 1, wherein said fairly low glass transition organic binder is at least one member selected from the group consisting of styrene-butadiene-rubber binder based resins, styrene-acrylate resins, acrylic resins, polyvinylacetate, polyvinyl alcohol, vinyl-acrylic resins, vinyl versatate, vinyl-acrylic/styrene-butadiene-rubber copolymers, vinyl-acrylic/styrene-acrylate copolymers, vinyl-acrylic/acrylic copolymers, vinyl-acrylic/polyvinylacetate copolymers, vinyl-acrylic/polyvinyl alcohol copolymers, vinyl-acrylic/polyethylene copolymers, vinyl-acrylic/vinyl versatate copolymers, vinyl-acrylic resins combined with crosslinkable resins, vinyl-acrylic/styrene-butadiene-rubber copolymers combined with crosslinkable resins, vinyl-acrylic/styrene-acrylate copolymers combined with crosslinkable resins, vinyl-acrylic/acrylic copolymers combined with crosslinkable resins, vinyl-acrylic/polyvinylacetate copolymers combined with crosslinkable resins, vinyl-acrylic/polyvinyl alcohol copolymers combined with crosslinkable resins, acrylic/polyethylene copolymers combined with crosslinkable resins and vinyl-acrylic/vinyl versatate copolymers combined with crosslinkable resins.

8. A wear resistant coated facing material comprising:
a plurality of randomly oriented reinforcement fibers bonded with a binder resin; and
a wear resistant coating layer on at least a portion of a first major side of said plurality of randomly oriented reinforcement fibers, said coating layer including:
a fairly low glass transition organic binder;
at least one thickening agent; and
particles having a hardness of at least 5 on the Mohs Hardness Scale and a particle size from about 1.0 micron to about 20.0 microns.

9. The wear resistant coated facing material of claim 8, wherein said reinforcement fibers are selected from the group consisting of glass fibers, mineral fibers, carbon fibers, ceramic fibers, synthetic fibers and combinations thereof.

10. The wear resistant coated facing material of claim 9, wherein said coating layer further comprises at least one member selected from the group consisting of one or more pigment materials, at least one defoaming agent, at least one dispersing agent and at least one biocide.

11. The wear resistant coated facing material of claim 8, wherein said coating layer partially penetrates into said plurality of randomly oriented reinforcement fibers.

12. The wear resistant coated facing material of claim 8, wherein said fairly low glass transition organic binder is at least one member selected from the group consisting of styrene-butadiene-rubber binder based resins, styrene-acrylate resins, acrylic resins, polyvinylacetate, polyvinyl alcohol, vinyl-acrylic resins, vinyl versatate, vinyl-acrylic/styrene-butadiene-rubber copolymers, vinyl-acrylic/styrene-acrylate copolymers, vinyl-acrylic/acrylic copolymers, vinyl-acrylic/polyvinylacetate copolymers, vinyl-acrylic/polyvinyl alcohol copolymers, vinyl-acrylic/polyethylene copolymers, vinyl-acrylic/vinyl versatate copolymers, vinyl-acrylic resins combined with crosslinkable resins, vinyl-acrylic/styrene-butadiene-rubber copolymers combined with crosslinkable resins, vinyl-acrylic/styrene-acrylate copolymers combined with crosslinkable resins, vinyl-acrylic/acrylic copolymers combined with crosslinkable resins, vinyl-acrylic/polyvinylacetate copolymers combined with crosslinkable resins, vinyl-acrylic/polyvinyl alcohol copolymers combined with crosslinkable resins, acrylic/polyethylene copolymers combined with crosslinkable resins and vinyl-acrylic/vinyl versatate copolymers combined with crosslinkable resins.

13. The wear resistant coated facing material of claim 8, wherein said particles are selected from the group consisting of alumina, pumice, feldspar, barite minerals, quartz, diamond, boron carbide, cuttlebone, garnet, silicone carbide, tungsten carbide, zirconium, amalgan, topaz, aptite and combinations thereof.

14. The wear resistant coated facing material of claim 8, further comprising a fibrous product affixed to a second major side of said plurality of randomly oriented reinforcement fibers.

15. The wear resistant coated facing material of claim 14, wherein said fibrous product is selected from the group consisting of a continuous filament mat, woven fabrics, meltbond materials, spunbond non-wovens and long fiber dry-laid non-woven mats.

16. A wear resistant gypsum board comprising:
a gypsum core having first and second major surfaces and first and second minor surfaces;
a first base veil comprising a first plurality of randomly oriented reinforcement fibers bonded with a first binder resin, said first base veil being mechanically bonded to said first major surface, said first and second minor surfaces, and at least a portion of said second major surface of said gypsum core;
a second base veil comprising a second plurality of randomly oriented reinforcement fibers bonded with a second binder resin, said second base veil being mechanically bonded to a portion of said second major surface of said gypsum core, said first and second base veils surrounding said gypsum core;
a wear resistant external coating on a major side of each of said first and second base veils opposing said gypsum core, said wear resistant external coating including:
a fairly low glass transition organic binder;
at least one thickening agent; and
particles having a hardness of at least 5 on the Mohs Hardness Scale and a particle size from about 1.0 micron to about 20.0 microns.

17. The wear resistant gypsum board of claim 16, wherein said first and second reinforcement fibers are selected from the group consisting of glass fibers, mineral fibers, carbon fibers, ceramic fibers, synthetic fibers and combinations thereof.

18. The wear resistant gypsum board of claim 17, wherein said wear resistant coating layer comprises one or more members selected from the group consisting of one or more pigment materials, at least one defoaming agent, at least one dispersing agent and at least one biocide.

19. The wear resistant gypsum board of claim 18, wherein said particles are selected from the group consisting of alumina, pumice, feldspar, barite minerals, quartz, diamond, boron carbide, cuttlebone, garnet, silicone carbide, tungsten carbide, zirconium, amalgan, topaz, aptite and combinations thereof.

20. The wear resistant gypsum board of claim 19, wherein said fairly low glass transition organic binder is at least one member selected from the group consisting of styrene-butadiene-rubber binder based resins, styrene-acrylate resins, acrylic resins, polyvinylacetate, polyvinyl alcohol, vinyl-acrylic resins, vinyl versatate, vinyl-acrylic/styrene-butadiene-rubber copolymers, vinyl-acrylic/styrene-acrylate copolymers, vinyl-acrylic/acrylic copolymers, vinyl-acrylic/polyvinylacetate copolymers, vinyl-acrylic/polyvinyl alcohol copolymers, vinyl-acrylic/polyethylene copolymers, vinyl-acrylic/vinyl versatate copolymers, vinyl-acrylic resins combined with crosslinkable resins, vinyl-acrylic/styrene-butadiene-rubber copolymers combined with crosslinkable resins, vinyl-acrylic/styrene-acrylate copolymers combined with crosslinkable resins, vinyl-acrylic/acrylic copolymers combined with crosslinkable resins, vinyl-acrylic/polyvinylacetate copolymers combined with crosslinkable resins, vinyl-acrylic/polyvinyl alcohol copolymers combined with crosslinkable resins, acrylic/polyethylene copolymers combined with crosslinkable resins and vinyl-acrylic/vinyl versatate copolymers combined with crosslinkable resins.
